(19) United States
(12) Patent Application Publication
(10) Pub. No.: US 2023/0208518 A1
(43) Pub. Date: Jun. 29, 2023

(54) OPTICAL WIRELESS COMMUNICATION DEVICE AND OPTICAL WIRELESS COMMUNICATION METHOD

(71) Applicant: NIPPON TELEGRAPH AND TELEPHONE CORPORATION, Tokyo (JP)

(72) Inventors: Takeshi IMAI, Musashino-shi, Tokyo (JP); Yushi KOYASAKO, Musashino-shi, Tokyo (JP); Keita NISHIMOTO, Musashino-shi, Tokyo (JP); Takashi YAMADA, Musashino-shi, Tokyo (JP)

(73) Assignee: NIPPON TELEGRAPH AND TELEPHONE CORPORATION, Tokyo (JP)

(21) Appl. No.: 17/926,705

(22) PCT Filed: May 26, 2020
(86) PCT No.: PCT/JP2020/020652

§ 371 Date: Nov. 21, 2022

(51) Int. Cl. H04B 10/112

(52) U.S. Cl. CPC H04B 10/1127

(57) ABSTRACT

An optical wireless communication system (1) for wirelessly transmitting a signal beam (L) between optical communication units (2) and (3) located at two points apart from each other includes an aiming mechanism (4) that is provided in each of the optical communication units (2) and (3) located at the two points and has an aiming line (S), which is parallel to an optical axis (O) and has a predetermined interval from the optical axis (O), with the optical axis (O) of the signal beam (L) of each of the optical communication units (2) and (3) located at the two points aligned in a straight line, and a first front sight that is provided in each of the optical communication units (2) and (3) and provided at a position that is off the optical axis (O) and the aiming line (S) and has a predetermined interval from the optical axis (O) and a predetermined interval from the aiming line (S).

### TECHNICAL FIELD

The present disclosure relates to a technique of an optical wireless communication apparatus and an optical wireless communication method.

### BACKGROUND ART

For an existing optical wireless communication apparatus for wirelessly transmitting a signal beam, such as a laser beam, between optical communication units located at two points apart from each other, a known method of positioning the optical wireless communication apparatus includes capturing an opposed optical communication unit with an aiming telescope installed in the optical wireless communication apparatus, roughly adjusting positions of the optical communication units and then finely adjusting the positions by using, for example, an optical power meter (refer to NPL 1, for example).

Furthermore, as disclosed in PTL 1, for example, the optical wireless communication apparatus to be applied to short-distance communication transmits a signal beam with optical lenses opposed to each other on both sides of a window glass. In this case, the apparatuses including the optical lenses opposed to each other are closely installed, thus allowing for easily grasping positional deviation as well as easily adjusting the positioning.

### CITATION LIST

### Patent Literature

PTL 1: JP 2007-259179 A

### Non Patent Literature

NPL 1: Report ITU-R F.2106.1 (11/2010)

### SUMMARY OF THE INVENTION

### Technical Problem

The existing optical wireless communication apparatus has following issues. NPL 1 described above applies a long transmission distance and allows for anticipating light incidence to the extent capable of fine adjustment. A wide spot diameter of the signal beam enables easy capture of the signal beam. This only requires rough adjustment with accuracy of simply visual alignment of optical axes by opposing the optical communication units to each other. Furthermore, PTL 1 described above enables easy adjustment of positional deviation and inclination because of the extremely short transmission distance.

Unfortunately, there has been room for improvement in a simple and suitable position adjustment method of the optical wireless communication apparatus for an intermediate distance in which the transmission distance to be applied is between the long distance and the short distance described above.

In response to the above circumstances, an object of the present disclosure is to provide a technique capable of highly accurate alignment of optical axes with a simple mechanism regardless of the transmission distance.

### Means for Solving the Problem

An aspect of the present disclosure is an optical wireless communication apparatus for wirelessly transmitting a signal beam between optical communication units located at two points apart from each other. The optical wireless communication apparatus includes an aiming mechanism that is provided in the optical communication units located at the two points and has an aiming line, which is parallel to an optical axis and has a predetermined interval from the optical axis, with the optical axis of the signal beam of each of the optical communication units located at the two points aligned in a straight line, and a first front sight that is provided in each of the optical communication units and provided at a position that is off the optical axis and the aiming line and has a predetermined interval from the optical axis and a predetermined interval from the aiming line.

An aspect of the present disclosure is an optical wireless communication method for wirelessly transmitting a signal beam between optical communication units located at two points apart from each other by using the optical wireless communication apparatus described above. The optical wireless communication method includes creating the aiming line by using the aiming mechanism of each of the optical communication units located at the two points, positioning the first front sight of each of the optical communication units on a visual line parallel to the optical axis and the aiming line, and wirelessly transmitting the signal beam between the optical communication units located at the two points.

### Effects of the Invention

The present disclosure enables highly accurate alignment of optical axes with a simple mechanism regardless of the transmission distance.

### BRIEF DESCRIPTION OF DRAWINGS

FIG. 1 is a perspective view schematically illustrating a configuration of an optical wireless communication apparatus according to a first embodiment of the present disclosure.

FIG. 2 is a view illustrating a method of adjusting an optical axis alignment in the optical wireless communication apparatus illustrated in FIG. 1 viewed from an optical axis direction.

FIG. 3 is a view illustrating a method of adjusting an optical axis alignment in the optical wireless communication apparatus illustrated in FIG. 2 viewed from the optical axis direction.

FIG. 4 is a perspective view schematically illustrating a configuration of an optical wireless communication apparatus according to a second embodiment.

FIG. 5 is a perspective view schematically illustrating a configuration of an optical wireless communication apparatus according to a third embodiment.

FIG. 6 is a perspective view schematically illustrating a configuration of an optical wireless communication apparatus according to a fourth embodiment.

FIG. 7A is a view illustrating a method of adjusting an optical axis alignment in an optical wireless communication apparatus viewed from an optical axis direction.

FIG. 7B is a view illustrating a method of adjusting an optical axis alignment in an optical wireless communication apparatus viewed from an optical axis direction.

FIG. 7C is a view illustrating a method of adjusting an optical axis alignment in an optical wireless communication apparatus viewed from an optical axis direction.

FIG. 7D is a view illustrating a method of adjusting an optical axis alignment in an optical wireless communication apparatus viewed from an optical axis direction.

FIG. 8 is a perspective view schematically illustrating a configuration of an optical wireless communication apparatus according to a fifth embodiment.

FIG. 9 is perspective view schematically illustrating a method of adjusting an optical axis alignment in the optical wireless communication apparatus illustrated in FIG. 8.

FIG. 10 is a view illustrating a method of adjusting an optical axis alignment in an optical wireless communication apparatus viewed from an optical axis direction.

FIG. 11 is perspective view schematically illustrating a method of adjusting an optical axis alignment in the optical wireless communication apparatus illustrated in FIG. 8.

FIG. 12 is perspective view schematically illustrating a method of adjusting an optical axis alignment in the optical wireless communication apparatus illustrated in FIG. 8.

### DESCRIPTION OF EMBODIMENTS

Embodiments of the present disclosure will be described in detail with reference to the drawings.

### First Embodiment

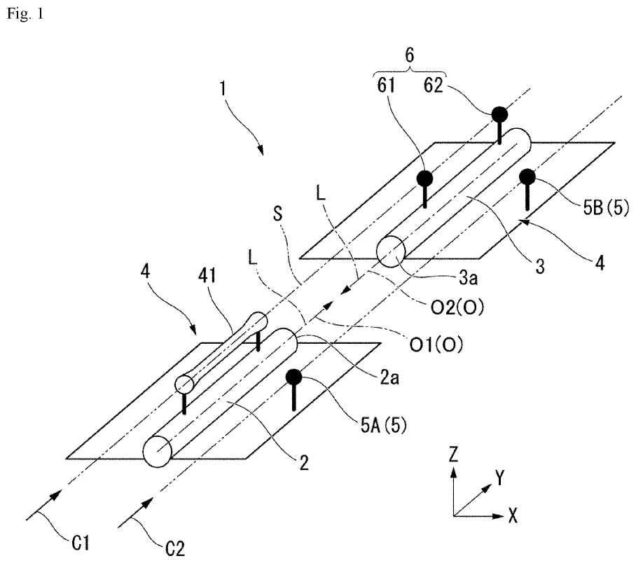

As illustrated in FIG. 1, an optical wireless communication apparatus 1 according to the present embodiment is an apparatus for wirelessly transmitting a signal beam L between optical communication units 2 and 3 located at two points apart from each other. The optical communication units 2 and 3 are disposed apart from each other in an optical axis direction as described above, and the signal beam L emitted from a first optical communication unit 2 is incident on a second optical communication unit 3. The first optical communication unit 2 and the second optical communication unit 3 each may be an optical fiber in which an optical lens, which is not illustrated, is provided on each of a tip surface 2a and a tip surface 3a, which are opposed to each other. Here, the optical axis of the optical communication unit 2 and the optical axis of the optical communication unit 3 are indicated by reference signs O1 and O2, respectively, and each of the optical axes is indicated by a reference sign O when both the optical axes O1 and O2 are aligned in a straight line.

The following description regards, in the optical axis direction, a front of a transmission direction of the signal beam L transmitted from the first optical communication unit 2 toward the second optical communication unit 3 as a distal side, and a rear opposite to the front as a proximal side. Furthermore, a direction going around a straight line parallel to the optical axis O (an aiming line S or a first visual line C1 to be described later) is defined as a circumferential direction, and a direction orthogonal to the optical axis O is defined as a radial direction viewed from the optical axis O direction.

An aiming mechanism 4 having the aiming line S parallel to the optical axis O (O1 and O2) and having a predetermined interval from the optical axis is provided with the signal beams L (optical axes O1 and O2) of the optical communication units 2 and 3 located at the two points aligned in a straight line, that is, with the optical axes aligned.

The aiming mechanism 4 includes an optical telescope 41 provided on the first optical communication unit 2 and a second front sight 6 (61 and 62) provided on the second optical communication unit 3, located on the aiming line S, and disposed at an interval in an aiming direction. Here, for the second front sight 6, a reference sign 61 is a second front sight located on a distal side, and a reference sign 62 is a second front sight located on a proximal side. The first optical communication unit 2 and the second optical communication unit 3 include a first front sight 5 (5A and 5B) at a position that is off the optical axis O and the aiming line S and has a predetermined interval from the optical axis O and a predetermined interval from an irradiation line 4A. In the present embodiment, the front sights 5 and 6 have the same diameter and are located on the same plane in a state in which optical axes of the first optical communication unit 2 and the second optical communication unit 3 are aligned with each other.

The optical telescope 41 is installed adjacent to the first optical communication unit 2 such that the optical axis (first visual line C1) is parallel to the optical axis O and separated at a predetermined distance from the optical axis O. As the optical telescope 41 to be used, for example, a telescope such as a sufficiently adjusted rifle scope may be used, which has one front sight in the mechanism and is well subjected to parallax correction. Furthermore, the optical telescope 41 to be used may have two or more focal planes in the mechanism of the optical telescope, and a front sight may be provided on each of the focal planes.

As described above, the first front sight 5A of the first optical communication unit 2 is disposed at a position that is off the first visual line C1 of the optical telescope 41 and the optical axis O by a predetermined distance.

The second front sights 61 and 62 provided as the aiming mechanism 4 of the second optical communication unit 3 opposed to the first optical communication unit 2 in an irradiation direction are disposed side by side on a straight line such that a straight line between the second front sights 61 and 62 is parallel to the optical axis O and located on the aiming line S. As described above, the first front sight 5B provided on the second optical communication unit 3 is disposed at a position that is off the first visual line C1 and the optical axis O by a predetermined distance.

A straight line between the first front sight 5A of the first optical communication unit 2 and the first front sight 5B of the second optical communication unit 3 is located on a second visual line C2 parallel to the aiming line S and the optical axis O.

The first front sight 5 and the second front sight 6 are disposed in a space and are formed in a circular dot shape in the present embodiment. Note that the shapes of the front sights 5 and 6 are not limited to the dot shapes as long as the front sights 5 and 6 occupy one point in the space and can be easily and visually recognized. The front sights 5 and 6 may be, for example, a rear sight for indicating a point in a space by a gap or may have a shape, for example, a cross line or a circular ring, other than the point, such as a reticle in the telescope.

To wirelessly transmit the signal beam L between the optical communication units 2 and 3 located at the two points apart from each other by using the optical wireless communication apparatus 1 having the above-described configuration, a positioning method of align both the optical axes O1 and O2 of the optical communication units 2 and 3 located at the two points will be specifically described.

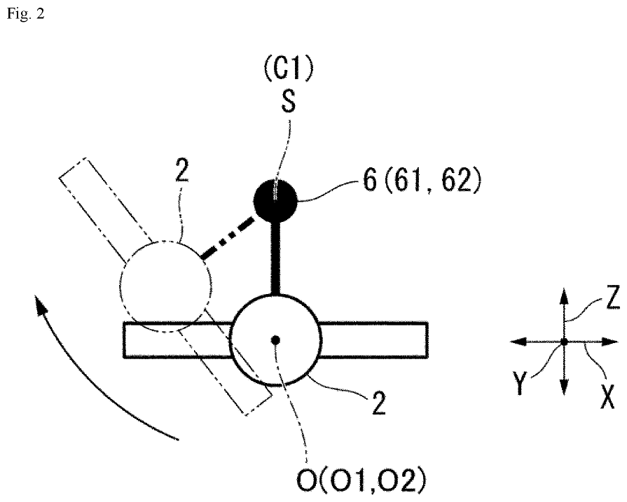

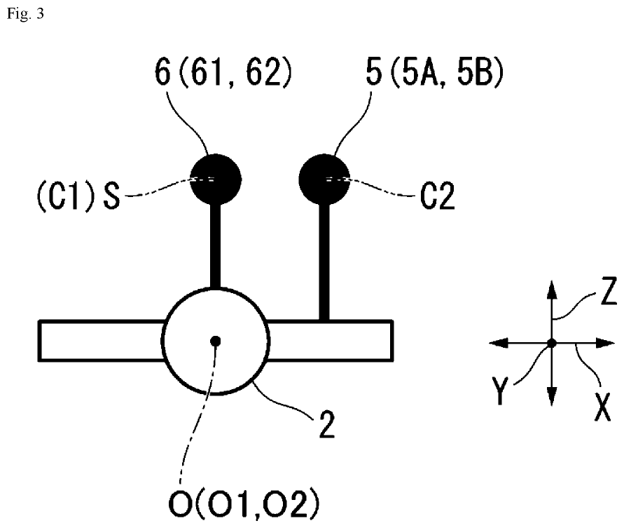

A method of positioning the optical axes O1 and O2 includes a first step of securing the aiming line S by using the aiming mechanism 4 of the optical communication units 2 and 3 as illustrated in FIG. 2, and a second step of positioning the first front sights 5A of the optical communication unit 2 and first front sight 5B of the optical communication unit 3 on the second visual line C2 parallel to the optical axis O and the aiming line S as illustrated in FIG. 3, after the first step.

Specifically, first, as illustrated in FIG. 2, by visually observing through the optical telescope 41 from a proximal side of the first visual line C1, the second front sights 61 and 62 are located on the first visual line C1, positions of the first optical communication unit 2 and the second optical communication unit 3 are adjusted, and thus the aiming line S is created. At this time, by adjusting the positions of the first optical communication unit 2 and the second optical communication unit 3, the optical axes O1 and O2 of the signal beams L of both the optical communication units 2 and 3 are parallel to each other. However, at this time, the optical axes O1 and O2 are not on the same axis line.

Next, as illustrated in FIG. 3, relatively rotating the first optical communication unit 2 and the second optical communication unit 3 in a circumferential direction about the aiming line S from a state in which the optical axes O1 and O2 are parallel to each other and visually positioning the first front sights 5A and 5B such that the first front sights 5A and 5B are located on the second visual line C2 and aligned in a straight line from a direction of the second visual line C2 causes a plane including the aiming line S to be flush with a plane including the second visual line C2.

By performing the adjustment in this manner, the optical axis alignment is completed which is made by positioning the optical axis O1 of the first optical communication unit 2 and the optical axis O2 of the second optical communication unit 3 on a straight line.

Note that a positioning accuracy of the optical axis O in the first optical communication unit 2 and the second optical communication unit 3 is dependent on apparent sizes (steradian) of the front sights 5 and 6. The sizes of the front sights 5 and 6 are determined in consideration of an allowable error to positioning of the first optical communication unit 2 and the second optical communication unit 3.

In the optical wireless communication apparatus 1 configured as described above, the aiming line S parallel to the optical axes O1 and O2 is created for both the optical communication units 2 and 3 located at the two points by using the aiming mechanism 4, and the first front sight provided in each of two of the optical communication units 2 and 3 located at the two points is located on the second visual line C2 that is a straight line parallel to the optical axes O1 and O2, and the aiming line S. Therefore, it is possible to easily adjust a deviation of the rotation about a Y-axis direction as a rotation center. This enables the optical axes O1 and O2 in the optical communication units 2 and 3 located at the two points to be accurately positioned on a straight line.

In the optical wireless communication apparatus and the optical wireless communication method according to the present embodiment, highly accurate alignment of optical axes can be performed with a simple mechanism regardless of the transmission distance.

### Second Embodiment

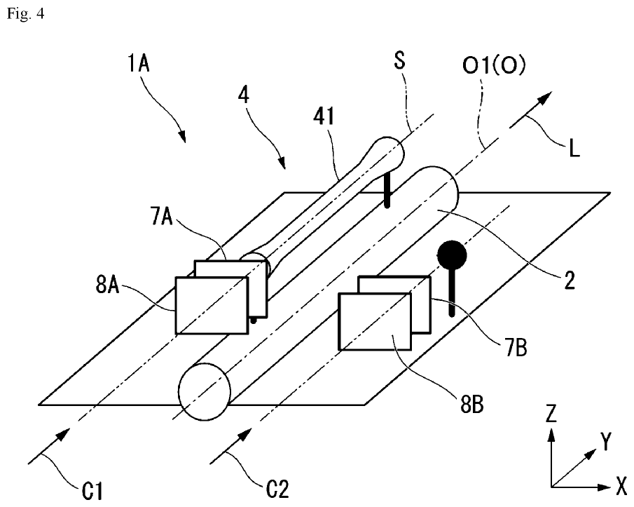

Next, an optical wireless communication apparatus 1A according to the second embodiment illustrated in FIG. 4 will be described.

The first embodiment described above has a configuration in which the first optical communication unit 2 and the second optical communication unit 3 are visually positioned, whereas the optical wireless communication apparatus 1A according to the second embodiment has a configuration in which the visual positioning is performed by image processing.

An aiming mechanism 4 according to the second embodiment includes a first camera 7A that is disposed behind an optical telescope 41 in an aiming direction in at least one first optical communication units 2 (only a first optical communication unit 2 is illustrated in FIG. 4) and images an aiming target point (second front sights 61 and 62 of a second optical communication unit 3 opposed to the first optical communication unit 2) on an aiming line S, and a first image processing unit 8A that processes an image of the aiming target point imaged by the first camera 7A.

Furthermore, a second camera 7B that images first front sights 5A and 5B of the optical communication units 2 and 3 located at two points, and a second image processing unit 8B that processes images of the first front sights 5A and 5B captured by the second camera 7B are provided behind a first front sight 5A of the first optical communication unit 2 of a first front sight 5.

The first camera 7A is connected to the first image processing unit 8A and image data captured by the first camera 7A is transmitted to the first image processing unit 8A. The first image processing unit 8A may be installed immediately behind the first camera 7A as in the present embodiment, or may be installed, for example, in a separate chamber separated from the first camera 7A. It is configured that an image analysis is performed by the first image processing unit 8A, and a position can be adjusted manually or automatically such that a pair of second front sights 61 and 62 are located on an aiming line S based on the processing result.

The second camera 7B is connected to the second image processing unit 8B and image data captured by the second camera 7B is transmitted to the second image processing unit 8B. The second image processing unit 8B may be installed immediately behind the second camera 7B as in the present embodiment, or may be installed, for example, in a separate chamber separated from the second camera 7B. It is configured that an image analysis is performed by the second image processing unit 8B, and a position can be adjusted manually or automatically such that a pair of first front sights 5A and 5B are located on a second visual line C2 based on the processing result.

In the optical wireless communication apparatus 1A according to the second embodiment, since it is not necessary to visually observe the aiming line S and the second visual line C2 when a position of an optical axis O is adjusted, it is possible to increase accuracy of optical axis alignment. The optical wireless communication apparatus 1A according to the second embodiment is suitable for alignment of optical axes particularly in an visually poor work environment, such as via an environment of sea, dust, or a space having low visibility, such as twilight, difficulty in identifying the opposing aiming mechanism.

### Third Embodiment

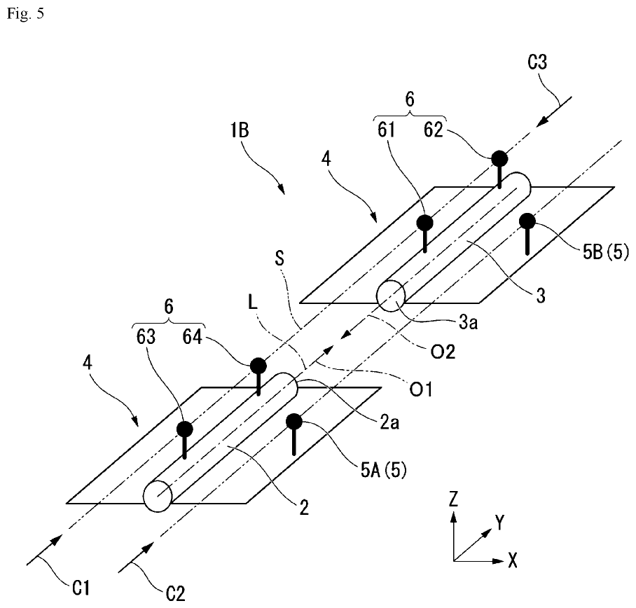

Next, an optical wireless communication apparatus 1B according to the third embodiment illustrated in FIG. 5 will be described.

The optical wireless communication apparatus 1B according to the third embodiment includes a second front sight 6 (63 and 64) instead of the optical telescope 41 provided in the first optical communication unit 2 of the first embodiment described above. In other words, a plurality (two) of the second front sights 6 (61, 62, 63, and 64) of an aiming mechanism 4 according to the third embodiment are provided in each of the optical communication units 2 and 3 located at two points, located on an aiming line S, and disposed at an interval in an aiming direction.

A pair of the second front sights 63 and 64 provided in the first optical communication unit 2 are installed such that a straight line between the second front sights 63 and 64 is parallel to optical axes O1 and O2 of the first optical communication unit 2. Furthermore, in the first optical communication unit 2, a first front sight 5A is disposed at the same position as that in the first embodiment.

A configuration of a second optical communication unit 3 is the same as that in the first embodiment described above and made such that a straight line connecting a pair of the second front sights 61 and 62 is parallel to the optical axis O2 of the second optical communication unit 3. Furthermore, in the second optical communication unit 3, a first front sight 5B is disposed at the same position as that in the first embodiment.

In the third embodiment, by positioning the first optical communication unit 2 and the second optical communication unit 3 such that all of the second front sights 61, 62, 63, and 64 of both the optical communication units 2 and 3 are aligned with each other on a first visual line C1 when performing a visual observation in a direction of the first visual line C1 on a proximal side of the second front sight 6 of the first optical communication unit 2 in an aiming direction, the aiming line S is created. At this time, by adjusting the positions of the first optical communication unit 2 and the second optical communication unit 3, the optical axes O1 and O2 of the signal beams L of both the optical communication units 2 and 3 are parallel to each other. However, at this time, the optical axes O1 and O2 are not on the same axis line.

Next, relatively rotating the first optical communication unit 2 and the second optical communication unit 3 in a circumferential direction about the aiming line S from a state in which the optical axes O are parallel to each other and visually positioning the first front sights 5A and 5B such that the first front sights 5A and 5B are located on a second visual line C2 and aligned in a straight line by performing a visual observation in a direction of the second visual line C2 causes a plane including the aiming line S to be flush with a plane including the second visual line C2 (refer to FIG. 3).

By performing the adjustment in this manner, the optical axis alignment is completed which is made by causing the optical axis O1 of the first optical communication unit 2 to align with the optical axis O2 of the second optical communication unit 3 on a straight line.

As described above, in the optical wireless communication apparatus 1B according to the third embodiment, the optical axis alignment can be accurately performed with a simple structure similarly to that of the first embodiment using the optical telescope 41 (refer to FIG. 1) described above. In this case, since the optical telescope 41 is unnecessary, a simpler structure is obtained, and the cost can be reduced.

Furthermore, in the third embodiment, a method of visually observing four of the second front sights 61 to 64 in a direction of the first visual line C1 is performed, and at the same time, a method of visually observing four of the second front sights 61 to 64 in a direction of a third visual line C3 from a distal side of the opposing second optical communication unit 3 may be performed. In this case, since the position adjustment is performed by using the first visual line C1 and the third visual line C3 of both sides of the optical communication units 2 and 3, the work time required for the adjustment can be reduced.

### Fourth Embodiment

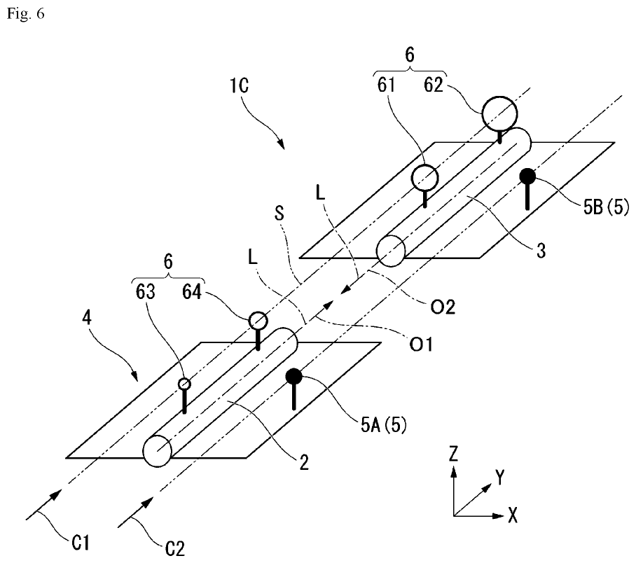

Next, an optical wireless communication apparatus 1C according to the fourth embodiment illustrated in FIG. 6 will be described.

The optical wireless communication apparatus 1C according to the fourth embodiment has a configuration in which shapes of second front sights 6 (61 to 64) provided in a first optical communication unit 2 and a second optical communication unit 3 of the third embodiment described above are changed. Note that the other configurations of the second front sights 6 are similar to that of the third embodiment, and thus detailed description thereof will be omitted here.

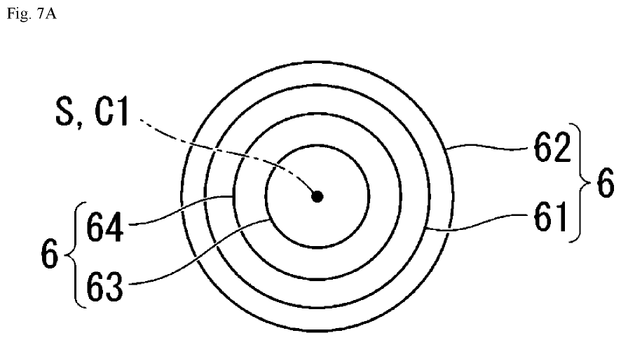

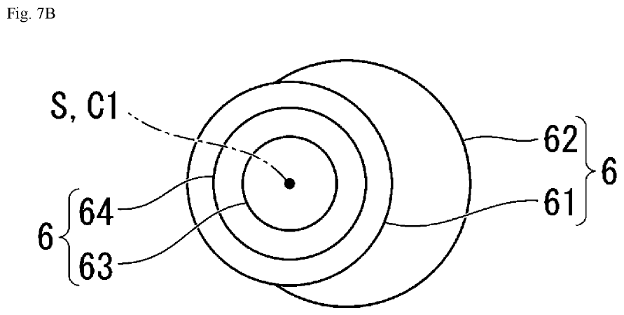

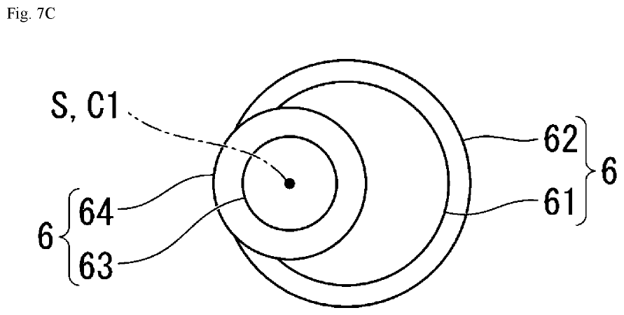

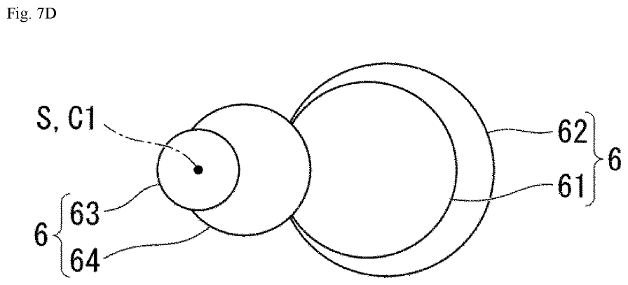

The second front sights 61 to 64 according to the fourth embodiment have a circular shape and diameters of the second front sights 61 to 64 are larger in an order from a proximal side to a distal side in an aiming direction. The second front sights 61 to 64 are disposed such that centers of the second front sights 61 to 64 penetrate along the aiming line S. A size of each of the second front sights 61 to 64 is set such that the distal second front sights 6 appears to stick out and overlap with the proximal front second front sight 6 (refer to FIGS. 7A to 7D).

In the fourth embodiment, in a case where the optical axis alignment is performed, centers of four of the second front sights 61 to 64 are positioned so as to be aligned on the aiming line S as illustrated in FIG. 7A when observing in a direction of the first visual line C1. In the present embodiment, as illustrated in FIGS. 7B to 7D, since it is easy to perform confirmation when a center of one of four of the second front sights 61 to 64 is deviated from the aiming line S, the adjustment is easily performed.

FIG. 7B illustrated a state in which the second front sight 62 located on the proximal side of the second optical communication unit 3 is located on a right side of the paper, and in this case, the second optical communication unit 3 is rotated about a Z-axis (rotated about a vertical direction on the paper of FIG. 7B) with respect to the first optical communication unit 2. FIG. 7C illustrates a state in which two of the second front sights 61 and 62 provided in the second optical communication unit 3 are deviated in parallel with two of the second front sights 63 and 64 provided in the first optical communication unit 2 in a right and left direction of the paper (X-axis direction), and in this case, the first optical communication unit 2 and the second optical communication unit 3 are relatively deviated from each other in the X-axis direction. FIG. 7D illustrates a state in which four of the second front sights 61 to 64 are deviated from each other in the right and left direction of the paper, and a state in which centers of a plurality of the second front sights 6 do not coincide with each other with respect to the first visual line C1. In this case, the first visual line C1 is not parallel to the aiming line S which is a straight line connecting four of the second front sights 61 to 64. In other words, the observation is performed with the first visual line C1 tilted with respect to the aiming line S.

As described above, in the optical wireless communication apparatus 1C according to the fourth embodiment, it is possible to easily confirm a situation of the axis deviation of the optical axes O1 and O2 of both the optical communication units 2 and 3 in a state in which the second front sights 61 to 64 overlap with each other in the distal side and the proximal side in a direction of the first visual line C1, and the adjustment time required for the alignment of the optical axes O1 and O2 can be reduced.

### Fifth Embodiment

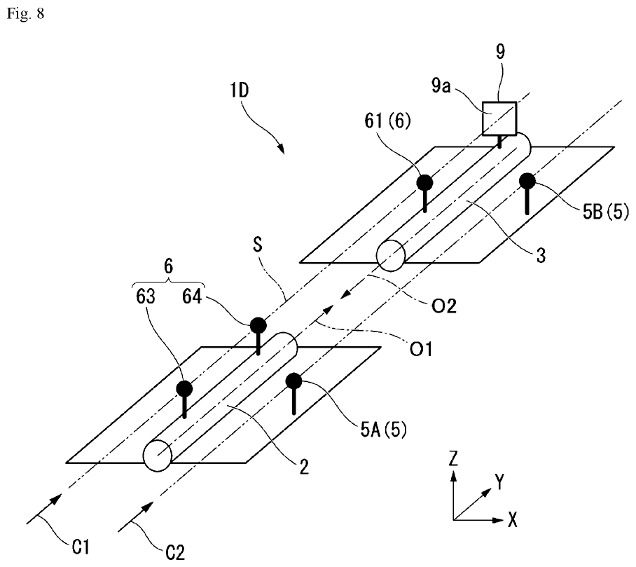

Next, an optical wireless communication apparatus 1D according to the fifth embodiment illustrated in FIG. 8 will be described.

The optical wireless communication apparatus 1D according to the fifth embodiment has a configuration in which a reflecting mirror 9 facing the first optical communication unit 2 side in an aiming direction is provided instead of the second front sight of the reference sign 62 located on a distal side of the second optical communication unit 3 in the third embodiment described above.

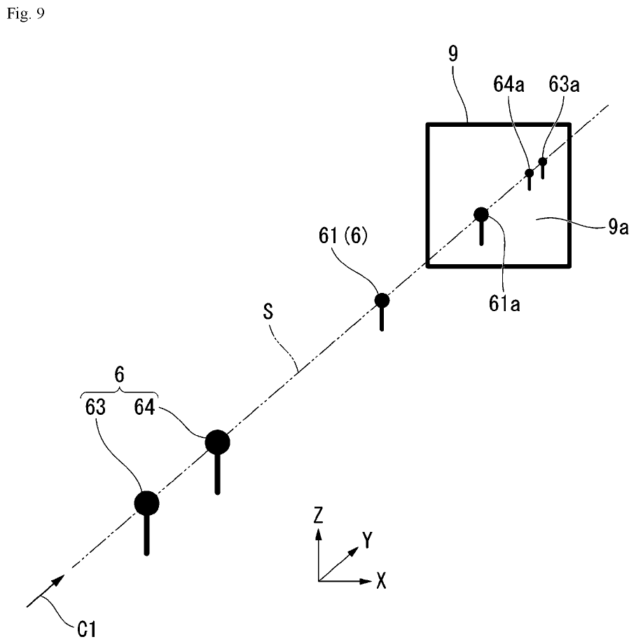

The reflecting mirror 9 of the aiming mechanism 4 according to the fifth embodiment is disposed on a distal side of the second optical communication unit 3 in the aiming direction, and as illustrated in FIG. 9, the reflecting mirror 9 is disposed such that three of the second front sights 61, 63, and 64, which are aiming target points on the aiming line S, are reflected on a reflecting surface 9a when observing in a direction of the first visual line C1. The reflecting mirror 9 is installed to have the reflecting surface 9a orthogonal to the aiming line S.

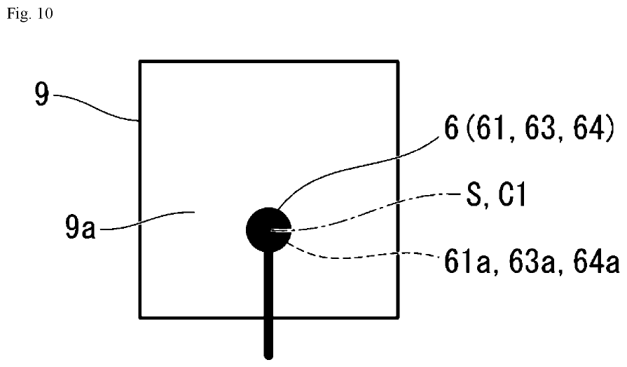

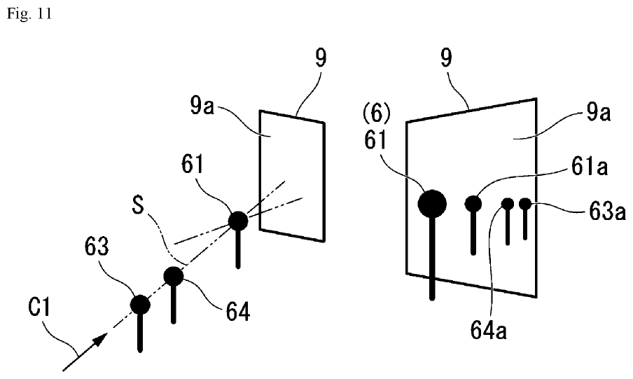

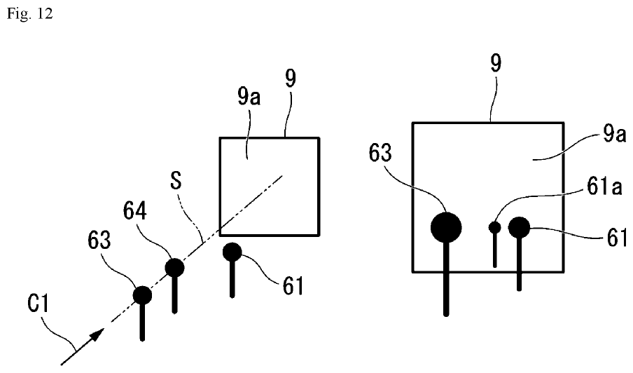

In the fifth embodiment, when the optical axis alignment is performed, as illustrated in FIG. 10, when observing in a direction of the first visual line C1, three of the second front sights 61, 63, and 64 as real images and three of the second front sights 61a, 63a, and 64a reflected on the reflecting mirror 9 are shown to be overlapped with each other and are located on the aiming line S and positioned so as to be aligned on a straight line. In the present embodiment, as illustrated in FIGS. 11 and 12, it is easy to perform confirmation when one of total six of the second front sights 61, 63, and 64 as real images, and the second front sights 61a, 63a, and 64a, which are images on the reflecting mirror 9, is deviated from the first visual line C1, the adjustment is easily performed.

FIG. 11 illustrates a state in which, when observing in a direction of the first visual line C1, the images of the second front sights 61a, 63a, and 64a reflected in the reflecting mirror 9 are shown to be deviated in the right and left direction which is the X-axis direction. At this time, the second optical communication unit 3 provided with the reflecting mirror 9 rotates about the Z-axis (about a vertical direction on the paper of FIG. 11). In this case, the second optical communication unit 3 is rotated about the Z-axis to adjust a position such that total six of the second front sights 61, 63, and 64 as real images and the second front sights 61a, 63a, and 64a as images of the reflecting mirror 9 are on a straight line.

FIG. 12 illustrates a state in which, when observing in a direction of the first visual line C1, only the image of the second front sight 61a reflected in the reflecting mirror 9 is shown to be deviated in parallel in the right and left direction which is the X-axis direction. In this case, the first optical communication unit 2 and the second optical communication unit 3 provided with the reflecting mirror 9 are deviated in parallel with the aiming line S.

As described above, in the optical wireless communication apparatus 1D according to the fifth embodiment, since the real image observing in a direction of the first visual line C1 and the image reflected in the reflecting mirror 9 are measured in a reciprocating manner, the positioning accuracy can be further improved.

Although the embodiments of the present disclosure have been described in detail with reference to the drawings, a specific configuration is not limited to the embodiments, and a design or the like in a range that does not depart from the gist of the present disclosure is included.

In the present embodiment, the optical telescope 41 that images the aiming target point with a visual observation or with a camera is adopted as the aiming mechanism 4, but the optical telescope is not limited thereto. For example, it is also possible to adopt a guide beam for aiming. However, in the case of the guide beam, since the light beam is further used in addition to the signal beam, a complex structure is made as compared to when using the optical telescope. Furthermore, in a case where a strong light beam such as a visible laser beam is radiated into the space as the guide beam, there is a need for a specific consideration to eye safety, which hinders the installation and operation of the optical wireless communication apparatus.

In addition, it is possible to appropriately replace the constituent elements in the above-described embodiments with well-known constituent elements without departing from the gist of the present disclosure.

### INDUSTRIAL APPLICABILITY

The present disclosure can be applied to the optical wireless communication apparatus capable of highly accurate alignment of optical axes with a simple mechanism, and the optical wireless communication method.

### REFERENCE SIGNS LIST

1, 1A, 1B, 1C, 1D Optical wireless communication apparatus
2 First optical communication unit
3 Second optical communication unit
4 Aiming mechanism
41 Optical telescope
5, 5A, 5B First front sight
6, 61 to 64 Second front sight
L Signal beam
O, O1, O2 Optical axis
C1 First visual line
C2 Second visual line
C3 Third visual line
S Aiming line

1. An optical wireless communication apparatus for wirelessly transmitting a signal beam between optical communication units located at two points apart from each other, the optical wireless communication apparatus comprising:
an aiming mechanism that is provided in each of the optical communication units located at the two points and has an aiming line, which is parallel to an optical axis and has a predetermined interval from the optical axis, with the optical axis of the signal beam of each of the optical communication units located at the two points aligned in a straight line; and
a first front sight that is provided in each of the optical communication units and provided at a position that is off the optical axis and the aiming line and has a predetermined interval from the optical axis and a predetermined interval from the aiming line.

2. The optical wireless communication apparatus according to claim 1, wherein
the aiming mechanism includes
an optical telescope provided on a first optical communication unit, which is one of the optical communication units located at the two points, and
a second front sight that is provided on a second optical communication unit, which is the other of the optical communication units located at the two points, and disposed on the aiming line apart from each other in an aiming direction.

3. The optical wireless communication apparatus according to claim 2, wherein
a plurality of the second front sights are provided in each of the optical communication units located at the two points and disposed on the aiming line apart from each other in the aiming direction.

4. The optical wireless communication apparatus according to claim 3, wherein
a distal front sight of the plurality of the second front sights provided in the optical communication units located at the two points have a larger shape than a proximal front sight of the plurality of the second front sights in the aiming direction.

5. The optical wireless communication apparatus according to claim 1, wherein
the aiming mechanism includes
a first camera that is disposed proximally in the aiming direction in at least one of the optical communication units and configured to image an aiming target point on the aiming line, and
a first image processing unit configured to process an image of the aiming target point imaged by the first camera.

6. The optical wireless communication apparatus according to claim 1, wherein
the aiming mechanism includes
a second camera configured to image the first front sight of each of the optical communication units located at the two points in at least one of a plurality of the first front sights, and
a second image processing unit configured to process an image of the first front sight imaged by the second camera.

7. The optical wireless communication apparatus according to claim 1, wherein
the aiming mechanism includes a reflecting mirror that is disposed distally in the aiming direction in either of the optical communication units and configured to reflect the aiming target point on the aiming line.

8. An optical wireless communication method for wirelessly transmitting a signal beam between optical communication units located at two points apart from each other by using an optical wireless communication apparatus according to claim 1, the optical wireless communication method comprising:
creating an aiming line by using an aiming mechanism of each of the optical communication units located at the two points;
positioning a first front sight of each of the optical communication units on a visual line parallel to an optical axis and the aiming line; and
wirelessly transmitting the signal beam between the optical communication units located at the two points.
